(19) United States
(12) Patent Application Publication
(10) Pub. No.: US 2026/0354618 A1
(43) Pub. Date: Nov. 12, 2026

(54) Coffee Making Appliance and Controlled Extraction Methods

(71) Applicant: Acaia Corporation, Alhambra, CA (US)

(72) Inventors: Rex Poway Tseng, Taipei (TW); Chien-Chun Han, Taipei (TW)

(21) Appl. No.: 19/670,868

(22) Filed: May 7, 2026

Related U.S. Application Data
(60) Provisional application No. 63/802,962, filed on May 9, 2025.

(51) Int. Cl. A47J 31/52; A23F 5/26; A47J 31/057; A47J 31/46

(52) U.S. Cl. CPC A47J 31/5255; A23F 5/262; A47J 31/057; A47J 31/461; A47J 31/468

(57) ABSTRACT

A coffee making appliance or method of operation includes include activating a fluid pump to motivate water to an extraction basket. The method may further include determining a fluid residence period at the extraction basket following activation of the fluid pump. The method may still further include directing the fluid pump and a release valve downstream from the extraction basket based on the determined fluid residence period.

### PRIORITY STATEMENT

The present application claims the benefit of priority to U.S. Provisional Patent Application Serial No. 63/802,962, filed on May 9, 2025, the disclosure of which is incorporated by reference herein in its entirety.

### FIELD OF THE DISCLOSURE

The present subject matter relates generally to coffee making appliances, and more particularly to systems and methods for controlling extraction during coffee making operations.

### BACKGROUND OF THE DISCLOSURE

Coffee, in its many forms and according to numerous brewing methods, is one of the most popular beverages throughout the world. Typical brewing methods broadly include immersion and percolation. In either case, coffee beans are ground into a powder (i.e., coffee grounds) before being introduced to water in order to extract various chemical compounds and flavors to create a coffee beverage.

Generally, the flavor and texture of a coffee beverage will be influenced or affected by both the mass ratio of coffee grounds to water, as well as the time in which a specific mass of water interacts (e.g., steeps, mixes, or strains through) the coffee grounds. Although automatic or automated systems for brewing coffee have existed for many years, such systems generally provide very little control or variability over the brewing process, especially when it comes to steps for percolation or immersion. For instance, common systems supply water to coffee grounds at a fixed rate or pattern. Subsequently, the brewed beverage is permitted to flow from the system at an uncontrolled rate. This can lead to a great deal of frustration, especially when attempting to brew different coffee varieties or roasts. Of course, manual methods, such as pour over or “French press” brewing methods permit a virtually infinite amount of variety and control. However, such methods can be very difficult to control or repeat. Moreover, most manual require a significant amount of knowledge, attention, and effort or be otherwise contingent on a particular user experience or mastery of technique.

### BRIEF DESCRIPTION OF THE DISCLOSURE

Aspects and advantages of the invention will be set forth in part in the following description, or may be obvious from the description, or may be learned through practice of the invention.

In one exemplary aspect of the present disclosure, a method of operating a coffee making appliance is provided. The method may include activating a fluid pump to motivate water to an extraction basket. The method may further include determining a fluid residence period at the extraction basket following activation of the fluid pump. The method may still further include directing the fluid pump and a release valve downstream from the extraction basket based on the determined fluid residence period.

In another exemplary aspect of the present disclosure, a coffee making appliance is provided. The appliance may include a base frame, a fluid pump, a shower head, an extraction basket, a release valve, a vessel, and a controller. The shower head may be supported on the base frame downstream from the fluid pump. The extraction basket may be disposed below the shower head. The release valve may be disposed on the base frame downstream from the extraction basket. The vessel may be removably disposed on the base frame downstream from the release valve. The controller may be operatively connected to the fluid pump and the release valve. The controller may be configured to direct a coffee-making operation including activating the fluid pump to motivate water to the extraction basket, determining a fluid residence period at the extraction basket following activation of the fluid pump, and directing the fluid pump and the release valve downstream from the extraction basket based on the determined fluid residence period.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 provides a schematic view of a coffee making appliance according to exemplary embodiments of the present disclosure.

FIG. 2 provides a schematic view of a controller according to exemplary embodiments of the present disclosure.

FIG. 3 provides a flow chart illustrating of a method of operating a coffee making appliance according to exemplary embodiments of the present disclosure.

FIG. 4 provides a flow chart illustrating of a method of operating a coffee making appliance according to exemplary embodiments of the present disclosure.

Repeat use of reference characters in the present specification and drawings is intended to represent the same or analogous features or elements of the present invention.

### DETAILED DESCRIPTION

Reference now will be made in detail to embodiments of the disclosure, one or more examples of which are illustrated in the drawings. Each example is provided by way of explanation of the disclosure, not limitation of the disclosure. In fact, it will be apparent to those skilled in the art that various modifications and variations can be made in the present disclosure without departing from the scope of the disclosure. For instance, features illustrated or described as part of one embodiment can be used with another embodiment to yield a still further embodiment. Thus, it is intended that the present disclosure covers such modifications and variations as come within the scope of the appended claims and their equivalents. The word “exemplary” is used herein to mean “serving as an example, instance, or illustration.” In addition, references to “an embodiment” or “one embodiment” does not necessarily refer to the same embodiment, although it may. Any implementation described herein as “exemplary” or “an embodiment” is not necessarily to be construed as preferred or advantageous over other implementations.

As used herein, the terms “first,” “second,” and “third” may be used interchangeably to distinguish one component from another and are not intended to signify location or importance of the individual components. The terms “includes” and “including” are intended to be inclusive in a manner similar to the term “comprising.” In addition, here and throughout the specification and claims, range limitations may be combined or interchanged. Such ranges are identified and include all the sub-ranges contained therein unless context or language indicates otherwise. For example, all ranges disclosed herein are inclusive of the endpoints, and the endpoints are independently combinable with each other. The singular forms “a,” “an,” and “the” include plural references unless the context clearly dictates otherwise.

Approximating language, as used herein throughout the specification and claims, may be applied to modify any quantitative representation that could permissibly vary without resulting in a change in the basic function to which it is related. Accordingly, a value modified by a term or terms, such as “generally,” “about,” “approximately,” and “substantially,” are not to be limited to the precise value specified. In at least some instances, the approximating language may correspond to the precision of an instrument for measuring the value, or the precision of the methods or machines for constructing or manufacturing the components or systems. For example, the approximating language may refer to being within a 10 percent margin (i.e., including values within ten percent greater or less than the stated value). In this regard, for example, when used in the context of an angle or direction, such terms include within ten degrees greater or less than the stated angle or direction (e.g., “generally vertical” includes forming an angle of up to ten degrees in any direction, such as, clockwise or counterclockwise, with the vertical direction V).

Except as explicitly indicated otherwise, recitation of a singular processing element (e.g., “a controller,” “a processor,” “a microprocessor,” etc.) is understood to include more than one processing element. In other words, “a processing element” is generally understood as “one or more processing element.” Furthermore, barring a specific statement to the contrary, any steps or functions recited as being performed by “the processing element” or “said processing element” are generally understood to be capable of being performed by “any one of the one or more processing elements.” Thus, a first step or function performed by “the processing element” may be performed by “any one of the one or more processing elements,” and a second step or function performed by “the processing element” may be performed by “any one of the one or more processing elements and not necessarily by the same one of the one or more processing elements by which the first step or function is performed.” Moreover, it is understood that recitation of “the processing element” or “said processing element” performing a plurality of steps or functions does not require that at least one discrete processing element be capable of performing each one of the plurality of steps or functions.

The terms “upstream” and “downstream” refer to the relative flow direction with respect to fluid flow in a fluid pathway. For example, “upstream” refers to the flow direction from which the fluid flows, and “downstream” refers to the flow direction to which the fluid flows.

Aspects of the present disclosure may provide a coffee making system or method for automatically (e.g., without direct user supervision or intervention) controlling coffee extraction. In particular, aspects of the present disclosure may advantageously permit automatic control over residence time for water within coffee grounds.

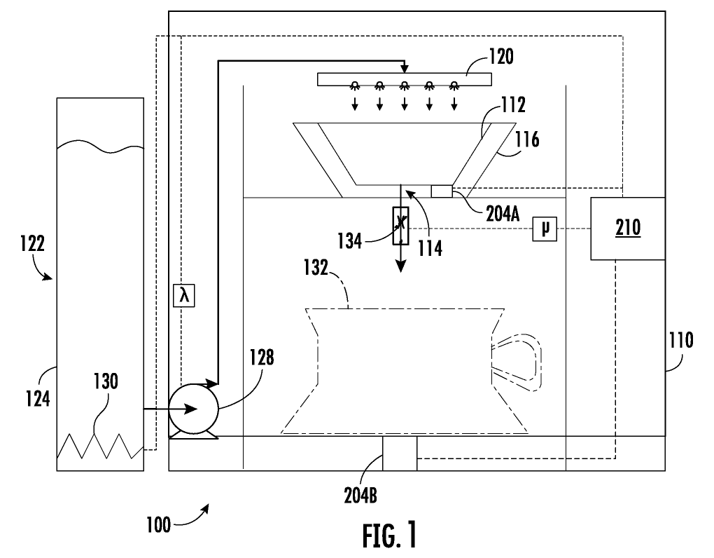

Turning now to the figures, FIG. 1 provides a schematic view of a coffee making appliance 100 according to exemplary embodiments of the present disclosure. Generally, the coffee making appliance 100 may include a base frame or body 110 that encloses, houses, or otherwise supports one or more other components of the coffee making appliance 100. For instance, the base frame 110 may include or be provided as a rigid structure formed from one or more polymers or metals (including combinations thereof) that can be placed or rest upon a countertop surface.

Attached or supported on the base frame 110 may be an extraction basket 112 into which coffee grounds may be placed. Generally, extraction basket 112 provides a preformed rigid or resilient (e.g., deformable), open, cup-shaped structure having one or more sidewalls or bottom wall defining a receiver volume for separately (e.g., at different points in time) receiving coffee grounds and water. One or more basket outlets 114 are defined through the extraction basket 112 (e.g., at a bottom end thereof), such as to permit brewed coffee or liquids to pass from the extraction basket 112 during (or following) brewing operations. Optionally, a basket nest 116 may be provided (e.g., on or within base frame 110) to cradle or otherwise support extraction basket 112. As would be understood, extraction basket 112 may include or be sized and shaped to receive a filtration insert, such as a metallic mesh or paper filter cone/basket. Thus, coffee grounds may be held within the filtration insert, which is itself held within the receiver volume of the extraction basket 112, to hold coffee grounds (e.g., without permitting the same to pass through the one or more basket outlets 114).

Disposed above the extraction basket 112 is a shower head 120. For instance, the shower head 120 may be fixedly or movably be mounted on or within the base frame 110 at a location above (e.g., directly above) the extraction basket 112 along a vertical direction. The shower head 120 may generally provide one or more head outlets through which water may pass before flowing to the extraction basket 112.

Generally, a water source 122 is provided upstream from the extraction basket 112 or shower head 120 and from which water may be supplied to the extraction basket 112 (e.g., through the shower head 120). In some embodiments, the water source 122 includes or is provided as a dedicated reservoir or water tank 124 (e.g., attached to or supported on a portion of the base frame 110), such as might include one or more solid tank walls or a removable lid for holding water within the water tank 124. Although generally provided as solid, nonpermeable structure, one or more tank outlets may be defined through the walls of the water tank 124 to permit the selective flow of water from the water tank 124 (e.g., to the shower head 120). Optionally, the water tank 124 may include or be provided as a connector to a domestic water source or utility, such as to permit the selective or steady release of water to the coffee making appliance 100.

A fluid or water pump 128 may be provided on fluid communication between the water source 122 and the shower head 120 (e.g., on or within the base frame 110), such as to motivate water therebetween. In particular, the water pump 128 may be disposed downstream from at least a portion the water source 122 (e.g., outside of or within the water tank 124) and upstream from the shower head 120. Thus, the water pump 128 may be selectively activated to motivate water from the water source 122 to the shower head 120. Generally, the water pump 128 may be provided as any suitable fluid pump for conveying water through the appliance 100, such as a centrifugal or impeller pump, peristaltic pump, vane pump, etc. In optional embodiments, the water pump 128 is a variable flow rate pump and may include a variable speed motor to selectively increase or decrease the flow rate of water through the water pump 128 to the shower head 120, as would be understood.

Separate from or in addition to the water pump 128, an electric heating element 130 may be provided upstream from the shower head 120. In particular, the electric heating element 130 may be provided on or within (e.g., in conductive thermal communication) at least a portion of the fluid path upstream from the shower head 120. As an example, the electric heating element 130 may be mounted on or within the water tank 124. Additionally or alternatively, the electric heating element 130 may be mounted apart from the water source 122, such as along the fluid flow path downstream from the water pump 128. Generally, the electric heating element 130 may be provided as any suitable electrically driven heating device capable of being selectively activated to directly or indirectly heat the water upstream from the shower head 120. For instance, the electric heating element 130 may include or be provided as a resistive heating element, induction heating element (e.g., cooperatively positioned relative to a ferrite material or segment for heating the same), or radiant or halogen heating element.

As illustrated, the base frame 110 may define a container region or void into which a vessel 132, such as a carafe, mug, or cup may be placed. In particular, the vessel 132 may be removably disposed or placed within the container region. Generally, the container region, and thus the vessel 132, may be provided downstream from the extraction basket 112. For instance, the container region and vessel 132 may be provided below (e.g., directly beneath) the extraction basket 112. In turn, the vessel 132 may receive liquid (e.g., a brewed coffee beverage) from the extraction basket 112 as motivated (at least in part) by gravity.

In fluid communication between the extraction basket 112 and the vessel 132 may be provided a release valve 134. For instance, the release valve 134 may be supported on the base frame 110 downstream from the extraction basket 112 and upstream from the container region (and thereby vessel 132). The release valve 134 may provide or define the sole outlet path from the extraction basket 112 to the container region and vessel 132. Thus, liquids passing to the vessel 132 from the extraction basket 112 may be required to flow through the release valve 134, thereby preventing any bypass flow to the vessel 132. In optional embodiments, the release valve 134 is disposed directly above the container region within which the vessel 132 is received. In turn, opening the release valve 134 may permit the flow of liquid (e.g., water or brewed beverage) to the vessel 132. By contrast, closing the release valve 134 may prevent or restrict the flow of liquid (e.g., water or brewed beverage) to the vessel 132. Generally, the release valve 134 may be provided as any suitable, electronically controlled (e.g., electric, pneumatic, or hydraulic) valve for selectively permitting restricting fluid therethrough, such as an electronically controlled ball valve, butterfly valve, gate valve, or vane valve. In some embodiments, release valve 134 is provided as a variable valve configured to move to one or more intermediate positions between a fully opened position and a fully closed position. In turn, flow through release valve 134 may be selectively varied (e.g., between a plurality of flow-rate settings) according to one or more electric signals or instructions.

Although shown in schematic form, it is understood that one or more pipes, tubes, or conduits may fluidly connect the various components of the coffee making appliance to convey water from the water source 122 and to the extraction basket 112, as well to convey a brewed beverage or liquid from the extraction basket 112 to the vessel 132. During use, such as during a brewing operation, water (e.g., heated water) from the water tank 124 may be conveyed to the shower head 120. Water may then flow out of the shower head 120 to the extraction basket 112. Within the extraction basket 112, water may be absorbed by, and mix with, particulate material (e.g., coffee grounds), such as to create a brewed beverage. The release or flow of the brewed beverage liquid from the extraction basket 112 to the vessel 132 may be controlled to directed by the selective opening-closing (e.g., including to one or more intermediate positions between fully open and fully closed) of the release valve 134. Through the release valve 134, the brewed beverage may pass to the vessel 132, which may be subsequently removed from the base frame 110 (e.g., such that a user may transport or consume the brewed beverage apart from the base frame 110).

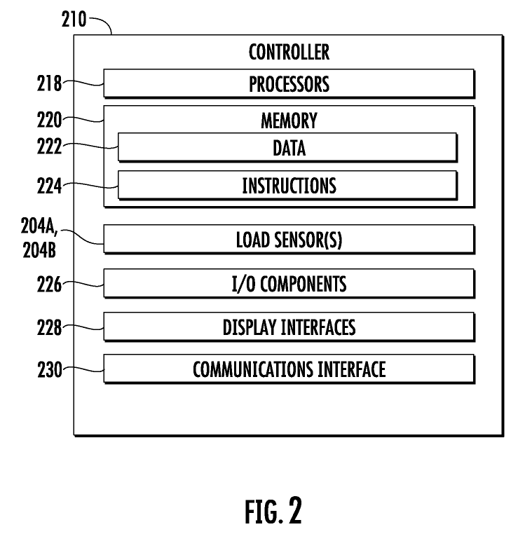

Turning now to FIGS. 1 and 2, a controller 210 may be attached to the base frame 110 and is generally provided in operable (e.g., wired or wireless) communication with one or more components of the appliance 100 (e.g., to control the same). Generally, the controller 210 includes one or more processors 218 and a memory 220. The one or more processors 218 can be any suitable processing device (e.g., a processor core, a microprocessor, an ASIC, a FPGA, a microcontroller, etc.) and can be one processor or a plurality of processors that are operatively connected. The memory 220 can include one or more non-transitory computer-readable storage mediums, such as RAM, ROM, EEPROM, EPROM, flash memory devices, magnetic disks, etc., and combinations thereof. The memory 220 can store data 222 and instructions 224 which are executed by the processor 218 to cause the controller 210 to perform operations.

The controller 210 can also include one or more user input component 226 that receives user input. For example, the user input component 226 can be a touch-sensitive component (e.g., a touch-sensitive display screen or a touch pad) that is sensitive to the touch of a user input object (e.g., a finger or a stylus). The touch-sensitive component can optionally serve to implement a virtual keyboard. Other example user input components include a microphone, a tactile or physical button, a traditional keyboard, or other means by which a user can provide user input.

In some implementations, the controller 210 can store or provide one or more user interfaces 228, such as the electronic display 216 (FIG. 1), which may be associated with one or more applications. The one or more user interfaces 228 can be configured to receive inputs or provide data for presentation or display (e.g., image data, text data, audio data, one or more user interface elements, an augmented-reality experience, a virtual reality experience, or other data for display). The user interfaces 228 may be associated with one or more other computing systems (e.g., a server computing system or third party computing system). The user interfaces 228 can include a viewfinder interface, a search interface, a generative model interface, a social media interface, or a media content gallery interface.

It is noted that, although not pictured, a suitable power source (e.g., battery, AC voltage port, etc.) could be provided in electrical communication with appliance 100 to electrically power the same (e.g., as is generally understood).

In some embodiments, controller 210 includes a communications interface 230 such that appliance 100 can connect to and communicate over one or more networks with one or more network nodes, such as secondary remote user device (e.g., smartphone, tablet, wearable device, or computer). Communications interface 230 can be an onboard component of controller 210 or it can be a separate, off board component. In some implementations, the communications interface 230 may include for example, one or more of a communications controller, receiver, transceiver, transmitter, port, conductors, software and/or hardware for communicating data/information. Controller 210 can also include one or more transmitting, receiving, or transceiving components for transmitting/receiving communications with other devices communicatively coupled with appliance 100. Additionally or alternatively, one or more transmitting, receiving, or transceiving components can be located off board controller 210.

The network can be any suitable type of network, such as a local area network (e.g., intranet), wide area network (e.g., internet), low power wireless networks [e.g., Bluetooth Low Energy (BLE)], or some combination thereof and can include any number of wired or wireless links. In general, communication over network can be carried via any type of wired or wireless connection, using a wide variety of communication protocols (e.g., TCP/IP, HTTP, SMTP, FTP), encodings or formats (e.g., HTML, XML), or protection schemes (e.g., VPN, secure HTTP, SSL).

In some embodiments, one or more scales or load sensors 204A, 204B are operably connected to controller 210. As an example, a basket sensor 204A may be provided and mounted in mechanical connection with the extraction basket 112. For instance, the basket sensor 204A may be mounted against the extraction basket 112 (e.g., between a bottom surface of the extraction basket 112 and an internal support surface of the basket nest 116). During use, a force or moment generated by the weight of the extraction basket 112 (and any material within the receiver volume) is transferred (at least in part) through the extraction basket 112 to the basket sensor 204A. In turn, the basket sensor 204A may be able to detect the mass of or within the extraction basket 112. Generally, basket sensor 204A is provided as or includes any suitable electronic load sensor or cell (e.g., one or more electronic load sensors or cells) configured to generate one or more electronic signals according (e.g., in proportion to) a mass of a load thereon. For instance, basket sensor 204A may include a suitable strain gauge, force sensitive resistor, capacitance sensor, hydraulic pressure sensor, or pneumatic pressure sensor—as would be understood. When assembled, the basket sensor 204A may be in operable (e.g., wireless or electrical) communication with a controller 210 to which the generated electronic signals may be communicated.

As an additional or alternative example, an assembly sensor 204B may be provided and mounted in mechanical connection with a lower portion of the base frame 110 (e.g., on which the extraction basket 112 and vessel 132 are supported). For instance, the assembly sensor 204B may be mounted a bottom platform of the base frame 110 (e.g., between a bottom surface of an upper surface “floating surface” of the bottom platform and a “fixed” lower surface of the bottom platform). During use, a force or moment generated by the weight of the extraction basket 112 and vessel 132 (and any material within either and both) is transferred (at least in part) through the bottom platform to the assembly sensor 204B. In turn, the assembly sensor 204B may be able to detect the mass of the extraction basket 112 and vessel 132 together. Generally, assembly sensor 204B is provided as or includes any suitable electronic load sensor or cell (e.g., one or more electronic load sensors or cells) configured to generate one or more electronic signals according (e.g., in proportion to) a mass of a load thereon. For instance, assembly sensor 204B may include a suitable strain gauge, force sensitive resistor, capacitance sensor, hydraulic pressure sensor, or pneumatic pressure sensor—as would be understood. As will be described in greater detail below, the assembly sensor 204B may be in operable (e.g., wireless or electrical) communication with a controller 210 to which the generated electronic signals may be communicated.

The controller 210 may include or receive data from one or more load sensors 204A, 204B. The one or more sensors 204A, 204B may be housed in a housing component that houses the one or more processors, the memory, or one or more hardware components, which may store, or cause to perform, one or more software packets.

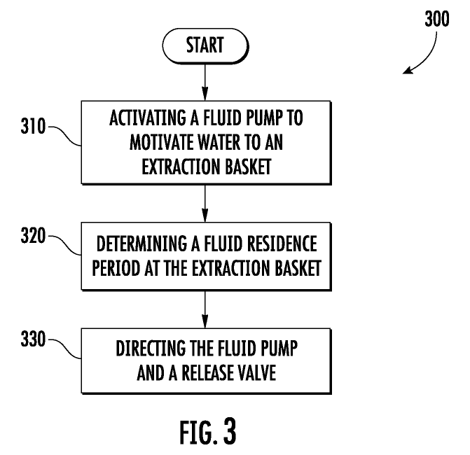

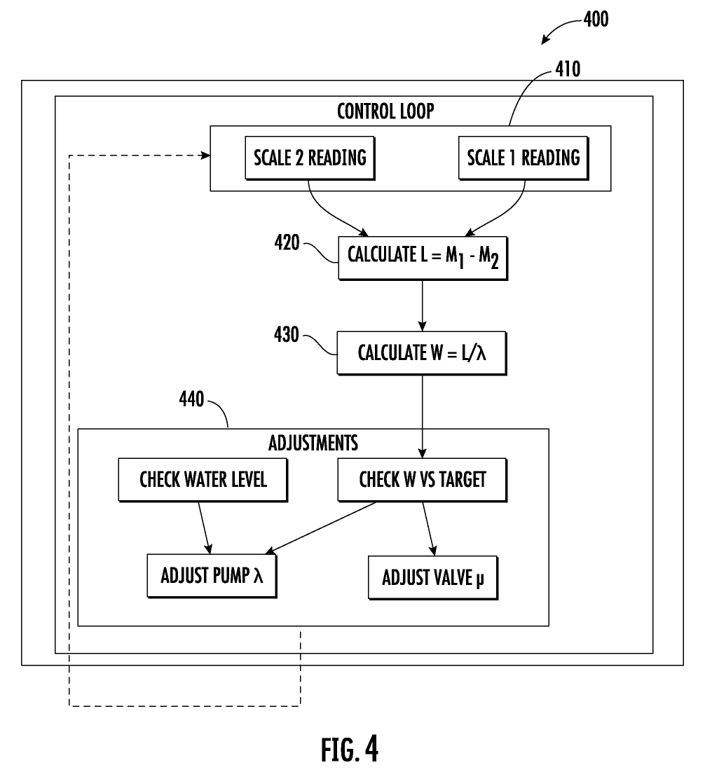

Turning now to FIGS. 3 and 4, the present disclosure may further be directed to methods (e.g., method 300 or 400) of operating an appliance, such as coffee making appliance 100. In exemplary embodiments, the controller 210 may be operable to perform various steps of a method in accordance with the present disclosure.

The methods (e.g., 300 or 400) may occur as, or as part of, a scale operation or calibration of a scale. In particular, the methods (e.g., 300 or 400) disclosed herein may advantageously facilitate controlled brewing of a beverage automatically (e.g., without direct user intervention beyond initiation or prompting of the operation).

It is noted that the order of steps within methods 300 and 400 are for illustrative purposes. Moreover, none of the methods 300 and 400 are mutually exclusive. In other words, methods within the present disclosure may include one or more of methods 300 and 400. All may be adopted or characterized as being fulfilled in a common operation. Except as otherwise indicated, one or more steps in the below method 300 and 400 may be changed, rearranged, performed in a different order, or otherwise modified without deviating from the scope of the present disclosure.

Turning especially to FIG. 3, at 310, the method 300 includes activating a fluid pump to motivate water to an extraction basket (e.g., in response to a user selection or other start signal indicating a prompt for coffee making operations). For instance, the fluid pump may be directed to motivate a set volume of liquid (e.g., water) from a connected water source (e.g., reservoir) to the extraction basket. The set volume may be determined, as an example, based on a user input or selection, such as a command for a desired volume of coffee or brewed beverage. The activation may be continuous or, alternatively, directed according to a predetermined pattern (e.g., discontinuous index pattern, which may include a “bloom phase pulse” or one or more “post-bloom pulses”). The fluid pump may be activated at a default or initial speed, such as a pump rotation speed or volumetric flow value. Optionally, the default or initial speed may be a predetermined value (e.g., flow-rate setting), such as a static programmed value or a previously calculated value (e.g., based on prior uses or measurement and comparisons to a programmed target speeds, as would be understood).

At 320, the method 300 includes determining a fluid residence period at the extraction basket (e.g., following 310). Thus, while the fluid pump is actively pumping fluid or following one or more pulses, the fluid residence period (e.g., time period of water retention within the extraction basket) may be calculated or estimated.

In some embodiments, 320 include measuring fluid retention (L) at the extraction basket. Thus, one or more values of mass, weight, or volume corresponding to liquid (e.g., water) within the extraction basket may be measured. As an example, the basket sensor may transmit one or more weight signals (e.g., received at the controller) corresponding to one or more detected weights at the extraction basket.

In certain embodiments, measuring fluid retention (L) includes detecting a basket weight (M2) of the extraction basket. One or more weight signals may be received from the basket sensor as a volume of water is being supplied to the extraction basket or following a volume of water being supplied (e.g., according to a pattern or pulse). In additional or alternative embodiments, measuring fluid retention (L) includes detecting an assembly weight (M1), which may include the extraction basket and a vessel. One or more weight signals may be received from the assembly sensor as a volume of water is being supplied to the extraction basket or following a volume of water being supplied (e.g., according to a pattern or pulse). Thus, a measurement of weight that covers not only fluid within the extraction basket but also within the vessel from the extraction basket may be determined. Optionally, the assembly weight (M1) may be detected simultaneously with the basket weight (M2). A calculation of fluid retention (L) may then be made, such as by subtracting M2 from M1 (i.e., such that L = M1 – M2).

In optional embodiments, 320 includes detecting a fluid level at the extraction basket. For instance, using the basket sensor or another suitable sensor, a volume or amount of water within the extraction basket may be determined. In some such embodiments, detecting the fluid level includes or is provided as detecting a basket weight (M2) of the extraction basket, as described above.

Separate from or in addition to measuring fluid retention (L), 320 may include detecting an input flow rate (λ) from the fluid pump to the extraction basket. For instance, input flow rate (λ) from the fluid pump to the extraction basket may be determined directly at the fluid pump (e.g., based on a voltage feedback or a control setting for the fluid pump), from an intermediate flow sensor over time, or indirectly based on one or more weight measurements over time.

In some embodiments, an average residence time (W) of liquid (e.g., period of time for liquid) within the extraction basket is determined. For instance, residence time (W) may be calculated as the time period for fluid retention (L) over the input flow rate (λ) from the fluid pump (i.e., such that W = L/λ).

In further embodiments, 320 includes detecting an output flow rate (μ) through the release valve. For instance, output flow rate (μ) from the release valve to the extraction basket may be determined directly at the release valve (e.g., based on a voltage feedback or a flow-rate setting for the release valve), from an intermediate flow sensor over time, or indirectly based on one or more weight measurements over time.

At 330, the method 300 includes directing the fluid pump and the release valve downstream from the extraction basket (e.g., based on the determined fluid residence period at 320).

In some embodiments, 330 includes comparing the detected fluid level to a target fluid level (e.g., stored within the controller or based on user input or selection, such as a command for a desired volume of coffee or brewed beverage). Upon or based on the comparison, 330 may include setting the input flow rate to the extraction basket, such as by changing or adjusting a setting for pump rotation speed (i.e., flow-rate setting). Thus, a contemporaneous pump rotation speed or volumetric flow rate may be changed (e.g., from an initial or previously adjusted speed setting). In some such embodiments, this includes changing an instructed value or voltage to the pump. If (e.g., in response to an instance wherein) the comparison determines that the detected fluid level is greater than the target fluid level (i.e., 330 includes determining the detected fluid level is greater than the target fluid level), 330 may further include reducing a flow-rate setting of the input flow rate at the fluid pump (e.g., by a fixed interval or, alternatively, in proportion to the determined difference). If (e.g., in response to an instance wherein) the comparison determines that the detected fluid level is less than the target fluid level (i.e., 330 includes determining the detected fluid level is less than the target fluid level), 330 may further include increasing a flow-rate setting of the input flow rate at the fluid pump (e.g., by a fixed interval or, alternatively, in proportion to the determined difference). In response to a comparison that determines the detected fluid level is equal to the target fluid level, the flow-rate setting of the input flow may be maintained.

In additional or alternative embodiments, 330 includes comparing the determined fluid residence period (W) to a target residence period (e.g., stored within the controller or based on user input or selection, such as a command for a desired volume of coffee or brewed beverage). Upon or based on the comparison, 330 may include setting the output flow rate through the release valve, such as by changing or adjusting a setting for relative flow area (i.e., flow-rate setting). Thus, a position or degree of openness for the release valve may be changed (e.g., from an initial or previously adjusted flow-rate setting). In some such embodiments, this includes changing an instructed value or voltage to the release valve. If (e.g., in response to an instance wherein) the comparison determines that the determined fluid residence period is greater than the target residence period (i.e., 330 includes determining the fluid residence period is greater than the target residence period), 330 may further include increasing a flow-rate setting of the output flow rate at the release valve (e.g., by a fixed interval or, alternatively, in proportion to the determined difference). If (e.g., in response to an instance wherein) the comparison determines that the determined fluid residence period is less than the target residence period (i.e., 330 includes determining the fluid residence period is less than the target residence period), 330 may further include reducing a flow-rate setting of the output flow rate at the release valve (e.g., by a fixed interval or, alternatively, in proportion to the determined difference). In response to a comparison that determines the determined fluid residence period is equal to the target residence period, the flow-rate setting of the output flow may be maintained.

Following 330, the method 300 may be repeated (e.g., as a closed loop), such as until a target volume is provided to the extraction basket or vessel.

Turning now to FIG. 4, at 410, the method 400 includes detecting an assembly weight (M1) at an assembly scale (i.e., reading scale 1) and detecting a basket weight (M2) of the extraction basket (i.e., reading scale 2). For instance, one or more weight signals may be received from the assembly scale, which may weigh the extraction basket and a vessel. One or more weight signals may be received from the assembly sensor as a volume of water is being supplied to the extraction basket or following a volume of water being supplied (e.g., according to a pattern or pulse). Thus, a measurement of weight that covers not only fluid within the extraction basket but also within the vessel from the extraction basket may be determined. Moreover, one or more weight signals may be received from the basket sensor as a volume of water is being supplied to the extraction basket or following a volume of water being supplied (e.g., according to a pattern or pulse). Optionally, the assembly weight (M1) may be detected simultaneously with the basket weight (M2).

Following or in response to 410, the method 400 may include 420. At 420, the method 400 includes measuring or calculating fluid retention. In particular, fluid retention (L) may be calculated in the difference of M2 from M1 (i.e., such that L = M1 – M2).

Following or in response to 420, the method 400 may include 430. At 430, the method 400 includes determining or calculating an average residence time (W) of liquid (e.g., period of time for liquid). In particular, average residence time (W) of liquid may be calculated as the time period for fluid retention (L) over the input flow rate (λ) from the fluid pump (i.e., such that W = L/λ).

Following or in response to 430, the method 400 may include 440. At 440, the method 400 includes updating flow-rate settings for the fluid pump and the release valve. For instance, 440 may include comparing the determined fluid residence period (W) to a target residence period (e.g., stored within the controller or based on user input or selection, such as a command for a desired volume of coffee or brewed beverage). Additionally or alternatively, 440 may include detecting a fluid level at the extraction basket. For instance, using the basket sensor or another suitable sensor, a volume or amount of water within the extraction basket may be determined. In some such embodiments, detecting the fluid level includes or is provided as detecting a basket weight (M2) of the extraction basket.

In certain embodiments, 440 includes determining the detected fluid level is greater than the target fluid level and the fluid residence period (W) is greater than the target residence period. In response to such a determination, 440 may include decreasing a flow-rate setting (λ) of the fluid pump (e.g., decreasing the pump rotation speed) and increasing a flow-rate setting (µ) of the release valve (e.g., further opening the release valve).

In additional or alternative embodiments, 440 includes determining the detected fluid level is greater than the target fluid level and the fluid residence period (W) is less than the target residence period. In response to such a determination, 340 may include decreasing a flow-rate setting (λ) of the fluid pump (e.g., decreasing the pump rotation speed) and decreasing a flow-rate setting (µ) of the release valve (e.g., further closing the release valve).

In further additional or alternative embodiments, 440 includes determining the detected fluid level is less than the target fluid level and the fluid residence period (W) is less than the target residence period. In response to such a determination, 340 may include increasing a flow-rate setting (λ) of the fluid pump (e.g., increasing the pump rotation speed) and decreasing a flow-rate setting (µ) of the release valve (e.g., further closing the release valve).

In yet further additional or alternative embodiments, 440 includes determining the detected fluid level is less than the target fluid level and the fluid residence period (W) is less than the target residence period. In response to such a determination, 440 may include increasing a flow-rate setting (λ) of the fluid pump (e.g., increasing the pump rotation speed) and increasing a flow-rate setting (µ) of the release valve (e.g., further opening the release valve).

Following 440, the method 400 may be repeated (e.g., as a closed loop), such as until a target volume is provided to the extraction basket or vessel.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A method of operating a coffee making appliance, the method comprising:
activating a fluid pump to motivate water to an extraction basket;
determining a fluid residence period at the extraction basket following activation of the fluid pump; and
directing the fluid pump and a release valve downstream from the extraction basket based on the determined fluid residence period.

2. The method of claim 1, wherein determining the fluid residence period comprises measuring fluid retention (L) at the extraction basket.

3. The method of claim 2, wherein measuring the fluid retention comprises
detecting an assembly weight (M1) of the extraction basket and a vessel, and
detecting a basket weight (M2) of the extraction basket.

4. The method of claim 2, wherein determining the fluid residence period further comprises
detecting an input flow rate from the fluid pump to the extraction basket, and
detecting an output flow rate through the release valve.

5. The method of claim 1, wherein determining the fluid residence period comprises detecting a fluid level at the extraction basket.

6. The method of claim 5, wherein directing the fluid pump and the release valve comprises
comparing the detected fluid level to a target fluid level,
comparing the determined fluid residence period to a target residence period, and
setting an input flow rate to the extraction basket and an output flow rate through the release valve based on the comparison of the detected fluid level and the comparison of the determined fluid residence period.

7. The method of claim 6, wherein comparing the detected fluid level to the target fluid level further comprises determining the detected fluid level is greater than the target fluid level,
wherein comparing the determined fluid residence period to the target residence period further comprises determining the determined fluid residence period is greater than the target residence period, and
wherein setting the input flow rate to the extraction basket and the output flow rate through the release valve comprises
reducing a flow-rate setting of the input flow rate at the fluid pump, and
increasing a flow-rate setting of the output flow rate at the release valve.

8. The method of claim 6, wherein comparing the detected fluid level to the target fluid level further comprises determining the detected fluid level is greater than the target fluid level,
wherein comparing the determined fluid residence period to the target residence period further comprises determining the determined fluid residence period is less than the target residence period, and
wherein setting the input flow rate to the extraction basket and the output flow rate through the release valve comprises
reducing a flow-rate setting of the input flow rate at the fluid pump, and
reducing a flow-rate setting of the output flow rate at the release valve.

9. The method of claim 6, wherein comparing the detected fluid level to the target fluid level further comprises determining the detected fluid level is less than the target fluid level,
wherein comparing the determined fluid residence period to the target residence period further comprises determining the determined fluid residence period is less than the target residence period, and
wherein setting the input flow rate to the extraction basket and the output flow rate through the release valve comprises
increasing a flow-rate setting of the input flow rate at the fluid pump, and
reducing a flow-rate setting of the output flow rate at the release valve.

10. The method of claim 6, wherein comparing the detected fluid level to the target fluid level further comprises determining the detected fluid level is less than the target fluid level,
wherein comparing the determined fluid residence period to the target residence period further comprises determining the determined fluid residence period is greater than the target residence period, and
wherein setting the input flow rate to the extraction basket and the output flow rate through the release valve comprises
increasing a flow-rate setting of the input flow rate at the fluid pump, and
increasing a flow-rate setting of the output flow rate at the release valve.

11. A coffee making appliance comprising:
a base frame;
a fluid pump;
a shower head supported on the base frame downstream from the fluid pump;
an extraction basket disposed below the shower head;
a release valve disposed on the base frame downstream from the extraction basket;
a vessel removably disposed on the base frame downstream from the release valve; and
a controller operatively connected to the fluid pump and the release valve, the controller being configured to direct a coffee-making operation comprising
activating the fluid pump to motivate water to the extraction basket,
determining a fluid residence period at the extraction basket following activation of the fluid pump, and
directing the fluid pump and the release valve downstream from the extraction basket based on the determined fluid residence period.

12. The coffee making appliance of claim 11, wherein determining the fluid residence period comprises measuring fluid retention (L) at the extraction basket.

13. The coffee making appliance of claim 12, wherein measuring the fluid retention comprises
detecting an assembly weight (M1) of the extraction basket and the vessel, and
detecting a basket weight (M2) of the extraction basket.

14. The coffee making appliance of claim 12, wherein determining the fluid residence period further comprises
detecting an input flow rate from the fluid pump to the extraction basket, and
detecting an output flow rate through the release valve.

15. The coffee making appliance of claim 11, wherein determining the fluid residence period comprises detecting a fluid level at the extraction basket.

16. The coffee making appliance of claim 15, wherein directing the fluid pump and the release valve comprises
comparing the detected fluid level to a target fluid level,
comparing the determined fluid residence period to a target residence period, and
setting an input flow rate to the extraction basket and an output flow rate through the release valve based on the comparison of the detected fluid level and the comparison of the determined fluid residence period.

17. The coffee making appliance of claim 16, wherein comparing the detected fluid level to the target fluid level further comprises determining the detected fluid level is greater than the target fluid level,
wherein comparing the determined fluid residence period to the target residence period further comprises determining the determined fluid residence period is greater than the target residence period, and
wherein setting the input flow rate to the extraction basket and the output flow rate through the release valve comprises
reducing a flow-rate setting of the input flow rate at the fluid pump, and
increasing a flow-rate setting of the output flow rate at the release valve.

18. The coffee making appliance of claim 16, wherein comparing the detected fluid level to the target fluid level further comprises determining the detected fluid level is greater than the target fluid level,
wherein comparing the determined fluid residence period to the target residence period further comprises determining the determined fluid residence period is less than the target residence period, and
wherein setting the input flow rate to the extraction basket and the output flow rate through the release valve comprises
reducing a flow-rate setting of the input flow rate at the fluid pump, and
reducing a flow-rate setting of the output flow rate at the release valve.

19. The coffee making appliance of claim 16, wherein comparing the detected fluid level to the target fluid level further comprises determining the detected fluid level is less than the target fluid level,
wherein comparing the determined fluid residence period to the target residence period further comprises determining the determined fluid residence period is less than the target residence period, and
wherein setting the input flow rate to the extraction basket and the output flow rate through the release valve comprises
increasing a flow-rate setting of the input flow rate at the fluid pump, and
reducing a flow-rate setting of the output flow rate at the release valve.

20. The coffee making appliance of claim 16, wherein comparing the detected fluid level to the target fluid level further comprises determining the detected fluid level is less than the target fluid level,
wherein comparing the determined fluid residence period to the target residence period further comprises determining the determined fluid residence period is greater than the target residence period, and
wherein setting the input flow rate to the extraction basket and the output flow rate through the release valve comprises
increasing a flow-rate setting of the input flow rate at the fluid pump, and
increasing a flow-rate setting of the output flow rate at the release valve.
